(19) United States
(12) Patent Application Publication
(10) Pub. No.: US 2020/0096825 A1
(43) Pub. Date: Mar. 26, 2020

(54) LIQUID CRYSTAL DISPLAY

(71) Applicant: SHARP KABUSHIKI KAISHA, Osaka (JP)

(72) Inventors: TOMONORI ITOH, Sakai City, Osaka (JP); MASANOBU MIZUSAKI, Sakai City, Osaka (JP)

(21) Appl. No.: 16/577,265

(22) Filed: Sep. 20, 2019

Related U.S. Application Data
(60) Provisional application No. 62/733,821, filed on Sep. 20, 2018.

(51) Int. Cl. G02F 1/1337

(52) U.S. Cl. CPC G02F 1/133711; G02F 2201/121; G02F 2201/123; G02F 1/133734

(57) ABSTRACT

A liquid crystal display at least including: a pair of substrates constituted by one substrate and another substrate, an electrode and an alignment film formed in this order on each of the pair of substrates, and a liquid crystal layer held between the alignment films,
wherein the alignment films include a polymer, and
the electrode formed on the one substrate has a multilayered structure in which an aluminum film and a transparent electroconductive film are stacked in this order from the one substrate.

### TECHNICAL FIELD

The present invention relates to a liquid crystal display. More specifically, the present invention relates to a liquid crystal display in which flicker is suppressed.

### BACKGROUND ART

Liquid crystal displays at least include a pair of substrates constituted by one substrate and another substrate, an electrode and an alignment film formed in this order on each of the pair of substrates, and a liquid crystal layer held between the alignment films. For example, Japanese Patent No. 3913483 (Patent Literature 1) and Japanese Unexamined Patent Application Publication No. 2004-38004 (Patent Literature 2) describe general structures of liquid crystal displays.

Patent Literature 1 describes a technique in which an alignment film and the like are formed so as to contain ion-adsorptive fine particles surface-treated with an organosilicon compound or the like, to thereby trap ionic impurities in the liquid crystal layer. It is known that carriers (carrying an electrical charge, or charged) in the alignment film attract impurity ions in the liquid crystal layer; the impurity ions accumulate at the alignment film-liquid crystal layer interface, which causes generation of rDC; and this generation causes degradation of the display quality and reliability of the liquid crystal display. According to the technique of Patent Literature 1, ion-adsorptive fine particles contained in an alignment film and the like trap impurity ions, to cancel charges out, to thereby achieve improvements in the display quality and reliability.

Patent Literature 2 relates to a reflection-mode liquid crystal display. This display includes a pixel electrode substrate having a plurality of reflective pixel electrodes formed of a metal material,

a counter substrate having a transparent electrode disposed so as to face the pixel electrodes, and

liquid crystal injected between the pixel electrode substrate and the counter substrate. The surfaces of the plurality of pixel electrodes, the surfaces facing the transparent electrode, are covered with, via an insulating thin film, an electroconductive thin film formed of the same material as that of the transparent electrode. According to the technique of Patent Literature 2, a battery effect, which causes asymmetry of liquid crystal responses due to different electrode materials individually used for substrates facing each other, can be eliminated.

### CITATION LIST

### Patent Literature

[PTL 1] Japanese Patent No. 3913483

[PTL 2] Japanese Unexamined Patent Application Publication No. 2004-38004

### SUMMARY OF INVENTION

### Technical Problem

In general, as transparent electrodes, ITO films are widely used. However, in reflection-mode liquid crystal displays, a reflective electrode is normally formed of aluminum, and, on its uppermost layer, an IZO film is formed. On the other hand, as the counter electrode for the reflective electrode, an ITO film is used. ITO has a work function of 4.6 eV, and IZO has a work function of 4.9 eV. Thus, the ITO film and the IZO film have a difference in work function. In addition, a polymer (polyimide-based material) constituting an alignment film includes n-conjugated phenylene groups, and hence carrier injection into the alignment film (PI film) occurs. The carrier injection probability varies among different electrode materials. Thus, a difference in charge storage amounts (charges) occurs in alignment film-liquid crystal layer interfaces, resulting in ΔV.

Furthermore, for color reflection-mode liquid crystal displays, there has been a demand for higher contrast, and a vertical alignment mode is employed. In this case, negative liquid crystal, which tends to cause generation of impurities, is employed to exert a stronger effect of the difference in charge storage amounts (charges). Thus, occurrence of flicker has been problematic.

### Solution to Problem

(1) An aspect of the present invention provides a liquid crystal display at least including: a pair of substrates constituted by one substrate and another substrate, an electrode and an alignment film formed in this order on each of the pair of substrates, and a liquid crystal layer held between the alignment films,

wherein the alignment films include a polymer, and

the electrode formed on the one substrate has a multilayered structure in which an aluminum film and a transparent electroconductive film are stacked in this order from the one substrate.

(2) An embodiment of the present invention provides the liquid crystal display according to (1), further including an inorganic layer on the alignment film formed on the one substrate.

(3) An embodiment of the present invention provides the liquid crystal display according to (1) or (2), wherein the alignment film formed on the one substrate is an alignment film containing inorganic fine particles.

(4) An embodiment of the present invention provides the liquid crystal display according to (3), wherein the alignment film containing inorganic fine particles contains inorganic fine particles having a particle size of 1 to 50 nm, and a content of the inorganic fine particles relative to 100 parts by mass of the polymer is more than 0 mass % and less than 2.0 mass %.

(5) An embodiment of the present invention provides the liquid crystal display according to (3) or (4), wherein the inorganic fine particles are fine particles containing SiOx.

(6) An embodiment of the present invention provides the liquid crystal display according to any one of (3) to (5), wherein the inorganic fine particles are fine particles containing SiOx.AlOy (where x and y are the same or different numbers).

(7) An embodiment of the present invention provides the liquid crystal display according to any one of (1) to (6), wherein the polymer has a planar alignment group or a vertical alignment group.

(8) An embodiment of the present invention provides the liquid crystal display according to any one of (1) to (7), wherein the polymer includes a photoreactive functional group.

(9) An embodiment of the present invention provides the liquid crystal display according to (8), wherein the photoreactive functional group is selected from groups having an azobenzene skeleton, a cinnamate skeleton, and a cyclobutane ring.

(10) An embodiment of the present invention provides the liquid crystal display according to any one of (1) to (9), wherein the liquid crystal layer includes, as a liquid crystal material, a compound having an alkenyl skeleton.

(11) An embodiment of the present invention provides the liquid crystal display according to (10), wherein the compound having an alkenyl skeleton is at least one selected from the group consisting of compounds represented by formulas (C-1) to (C-4) below:

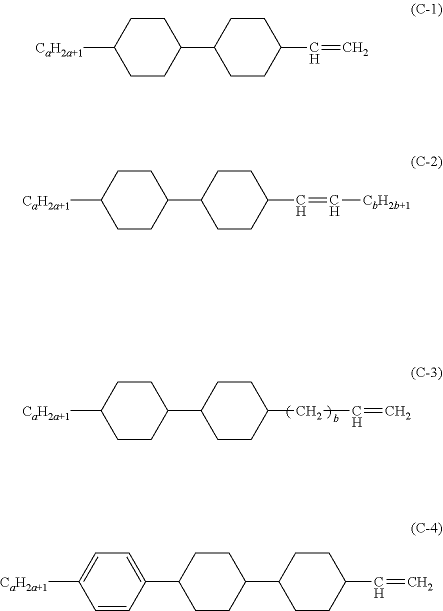

(where a and b independently represent an integer of 1 to 6).

(12) An embodiment of the present invention provides the liquid crystal display according to any one of (1) to (11), wherein the liquid crystal display is a reflection-mode display.

### Advantageous Effects of Invention

The present invention provides a liquid crystal display in which flicker is suppressed.

### BRIEF DESCRIPTION OF DRAWINGS

FIG. 1 illustrates problems of an existing liquid crystal display.

FIG. 2 illustrates an embodiment of the present invention for addressing the problems.

FIG. 3 is a schematic view of a liquid crystal display according to the present invention.

FIG. 4 is a schematic view of a liquid crystal display according to the present invention.

### DESCRIPTION OF EMBODIMENTS

Hereinafter, the present invention will be described in detail.

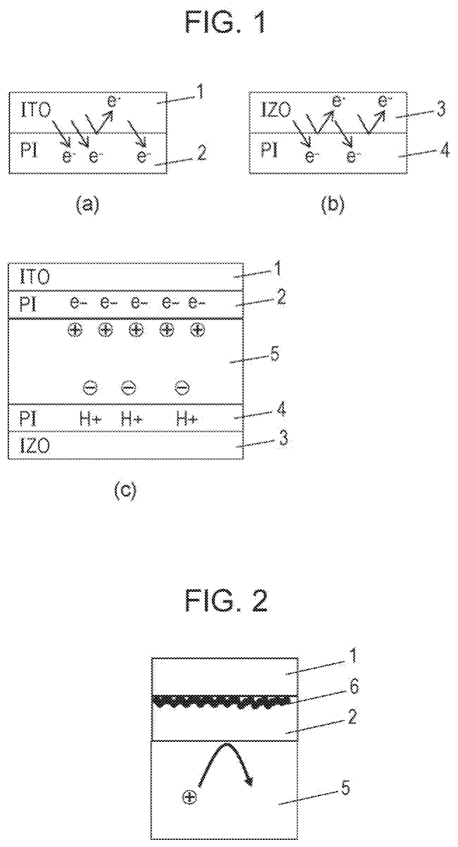

A liquid crystal display at least includes a pair of substrates constituted by one substrate and another substrate, an electrode and an alignment film formed in this order on each of the pair of substrates, and a liquid crystal layer held between such alignment films. Occurrence of flicker in an existing liquid crystal display will be described with reference to FIG. 1(a) to (c). FIG. 1(a) is a schematic sectional view of an electrode (in this drawing, formed of ITO) and an alignment film (PI) formed on one substrate. FIG. 1(b) is a schematic sectional view of an electrode (in this drawing, formed of IZO) and an alignment film (PI) formed on another substrate. FIG. 1(c) is a schematic view illustrating a state in which a difference exists between charge storage amounts. In the drawings, the reference sign 1 denotes the ITO film; the reference signs 2 and 4 denote the alignment films; the reference sign 3 denotes the IZO film; and the reference sign 5 denotes the liquid crystal layer.

In general, a reflection-mode liquid crystal display employs, as pixel electrodes (reflective electrodes), electrodes constituted by multilayered bodies of an aluminum film and an IZO film. On the other hand, as a common electrode serving as the counter electrode for the reflective electrodes, a transparent electrode is formed of ITO. ITO has a work function of 4.6 eV, and IZO has a work function of 4.9 eV, hence they have a difference. As a polymer constituting the alignment films, a polyimide-based material is mainly employed; this material includes n-conjugated phenylene groups, so that carrier injection into the alignment films occurs. The carrier injection probability varies among different materials constituting electrodes. Thus, charge storage amounts (charges) have a difference between alignment film-liquid crystal layer interfaces, resulting in occurrence of ΔV (refer to FIG. 1(c)). This ΔV causes occurrence of flicker.

In addition, for color reflection-mode liquid crystal displays, there has been a demand for higher contrast, hence, in general, the vertical alignment mode is employed. This mode employs negative liquid crystal, which tends to cause generation of impurities, to exert a stronger effect of the difference between charge storage amounts. As a result, occurrence of flicker becomes a bigger problem.

By contrast, in the present invention, the difference in charge storage amount (charge) between alignment film-liquid crystal layer interfaces is suppressed by a structure described below, to thereby suppress flicker.

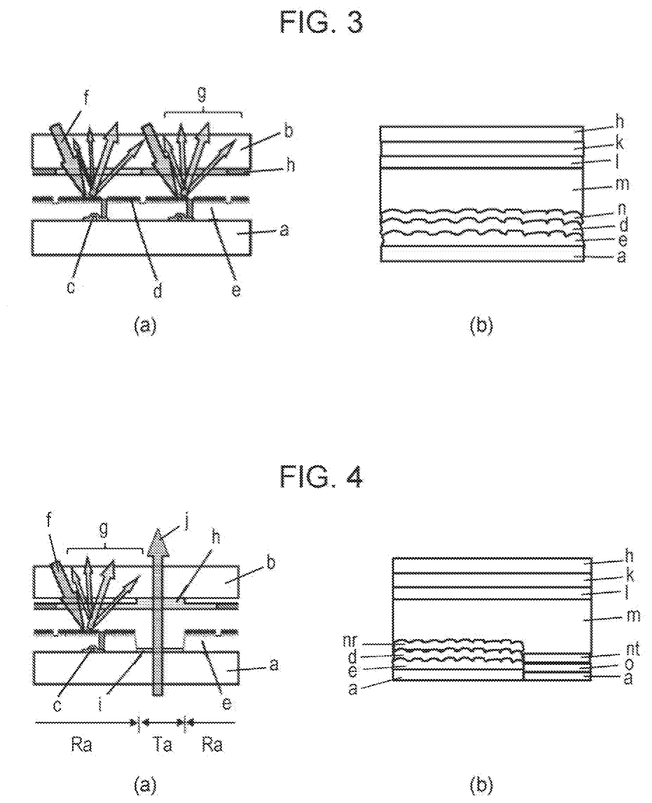

In particular, the present invention is effectively applicable to a reflection-mode liquid crystal display in which pixel electrodes are formed on one substrate, and a common electrode is formed on another substrate. FIG. 3(a) is a schematic sectional view of and FIG. 3(b) is an enlarged view of an example of the reflection-mode liquid crystal display. The present invention is also applicable to a semi-transmissive liquid crystal display having a configuration based on a reflection mode and partially including a transmission mode. FIG. 4(a) is a schematic sectional view of and FIG. 4(b) is an enlarged view of an example of the semi-transmission mode liquid crystal display. In the liquid crystal displays in these drawings, the pixel electrodes play the role of reflective electrodes, and the electrodes have, on their surfaces, micro-reflective structures (MRS). In these drawings, the reference sign a denotes the one substrate; the reference sign b denotes the other substrate; the reference sign c denotes a TFT; the reference sign d denotes a pixel electrode; the reference sign e denotes an insulating film; the reference sign f denotes incident light; the reference sign g denotes reflected light; the reference sign Ra denotes reflection regions; the reference sign Ta denotes a transmission region; the reference sign h denotes a color filter; the reference sign i denotes a transmissive electrode; the reference sign j denotes transmitted light; the reference sign k denotes a common electrode; the reference sign 1 denotes an alignment film; the reference sign m denotes a liquid crystal layer; the reference sign n denotes an alignment film; the reference sign nr denotes an alignment film in the reflection region; the reference sign nt denotes an alignment film in the transmission region; and the reference sign o denotes a transparent electrode.

The pixel electrodes and the common electrode include transparent electroconductive films. The material of the transparent electroconductive films is not particularly limited, but is preferably transparent electroconductive materials such as indium tin oxide (Indium Tin Oxide: ITO) and indium zinc oxide (Indium zinc Oxide: IZO).

### (Flicker Suppression Structure)

In particular, in the liquid crystal display, the electrode formed on the one substrate can have a flicker suppression structure constituted by a multilayered structure in which an aluminum film and a transparent electroconductive film are stacked in this order from the one substrate.

As described above, the pixel electrodes on the one substrate are formed so as to have a multilayered structure of an aluminum film and a transparent electroconductive film, so that the pixel electrodes are made to have a carrier injection probability closer to the carrier injection probability of the transparent electroconductive film generally used as a common electrode on the other substrate.

The transparent electroconductive film of the pixel electrodes is not particularly limited in terms of thickness; when the transparent electroconductive film is an ITO film, it may have a thickness of 50 to 500 Å, for example. When the thickness is less than 50 Å, it may be difficult to make the carrier injection probability closer to that of the electrode of the other substrate. When the thickness is more than 500 Å, the transmittance may decrease. The film thickness is preferably 100 to 300 Å, more preferably 100 to 110 Å.

In the present invention, structures (A) and/or (B) below may be further included. Incidentally, even in a liquid crystal display not having the above-described multilayered structure, but having the structures (A) and/or (B) below alone, flicker can be suppressed to a degree.

(b) Structure (A)

In this structure, an inorganic layer having a high resistance (a large bandgap relative to an alignment film) is formed on the alignment film formed on the one substrate, to thereby suppress injection of carriers from the electrodes into and charging of the alignment film. In this structure, impurity ions are less likely to be trapped at the alignment film-liquid crystal layer interface, to thereby achieve improvement in rDC.

The material constituting the inorganic layer is not particularly limited as long as injection of carriers and charging are suppressed. Examples include SiOx, AlOy, and SiOx.AlOy (where x and y are the same or different numbers). For example, x is 1 to 2, and y is 3/2. SiOx.AlOy may be zeolite.

The thickness of the inorganic layer is not particularly limited, but may be 500 to 1000 Å, for example. When the thickness is less than 500 Å, carrier injection and charging may be less likely to be suppressed. When the thickness is more than 1000 Å, the transmittance may decrease. The film thickness is preferably 500 to 550 Å.

The inorganic layer may cover the entirety of or a portion of the surface of the alignment film as long as it suppresses injection of carriers and charging.

The inorganic layer can be obtained by, for example, dispersing an inorganic substance in water or an organic solvent (such as a lower alcohol) to prepare a dispersion liquid, applying the dispersion liquid onto the alignment film to obtain a coating film, and subsequently drying the coating film.

(c) Structure (B)

In this structure, an alignment film is formed on the one substrate so as to contain inorganic fine particles having a high resistance (a large bandgap relative to the alignment film), to thereby suppress injection of carriers from the electrode into and charging of the alignment film. In this structure, impurity ions are less likely to be trapped at the alignment film-liquid crystal layer interface, to thereby achieve improvement in rDC.

The material constituting the inorganic fine particles is not particularly limited as long as injection of carriers and charging are suppressed. Examples include SiOx, AlOy, and SiOx.AlOy (where x and y are the same or different numbers). For example, x is 1 to 2, and y is 3/2. SiOx.AlOy may be zeolite.

The particle size of the inorganic fine particles is not particularly limited, but may be 1 to 50 nm, for example. When the particle size is less than 1 nm, carrier injection and charging may be less likely to be suppressed. When the particle size is more than 50 nm, the transmittance may decrease. The particle size is preferably 10 to 50 nm, more preferably 10 to 30 nm. The particle size means a value measured by dynamic light scattering, for example.

The inorganic fine particles may be uniformly present throughout the entirety of the alignment film or may be present in a portion of the alignment film alone as long as injection of carriers and charging are suppressed.

The concentration of inorganic fine particles in the alignment film relative to 100 parts by mass of the polymer constituting the alignment film may be, for example, more than 0 mass % and less than 2.0 mass %. When the concentration is 0 mass %, carrier injection and charging may be less likely to be suppressed. When the concentration is more than 2.0 mass %, scattering may occur. The concentration is preferably 0.5 to 1.5 mass %, more preferably 1.0 to 1.5 mass %.

The alignment film containing inorganic fine particles can be obtained by, dispersing inorganic fine particles in an alignment-film-forming solution to prepare a dispersion liquid, applying the dispersion liquid onto the electrode to obtain a coating film, and subsequently drying the coating film.

### (Pair of Substrates)

The pair of substrates may be any publicly known substrates without particular limitations. Examples include glass substrates and plastic substrates. In the case of a reflection-mode liquid crystal display, at least the other substrate is preferably transparent, and the one substrate may be transparent or opaque.

### (Electrodes)

The electrodes may be any publicly known electrodes without particular limitations. The present invention is particularly effective when the materials constituting the electrodes individually formed on the one substrate and the other substrate have different work functions. In general, the electrodes may be transparent electrodes containing gold, silver, copper, platinum, tin oxide, zinc oxide, indium oxide, antimony oxide, titanium oxide, indium tin oxide (ITO), indium zinc oxide (IZO), In-Ga—ZnO₄ (IGZO), or antimony-doped tin oxide (ATO). In the case of a reflection-mode liquid crystal display, pixel electrodes may not be transparent, and may be electrodes containing aluminum, tungsten, titanium, or titanium nitride, for example.

The thickness and the planar shape of the electrodes are not particularly limited, and may be appropriately adjusted in accordance with the desired performance of the liquid crystal display.

However, in the liquid crystal display according to (1), the pixel electrodes on the one substrate have, as described above, a multilayered structure of an aluminum film and a transparent electroconductive film.

In the liquid crystal display according to (1) to (3), the electrodes formed on the one substrate may include an ITO film, and the electrode formed on the other substrate may include an IZO film.

In the liquid crystal display according to (2) or (3), the electrodes formed on the one substrate may have a multilayered structure in which an aluminum film and an ITO film are stacked in this order from the one substrate.

In the liquid crystal display according to (1) to (3), the electrodes formed on the one substrate may have a multilayered structure in which an aluminum film and an ITO film are stacked in this order from the one substrate; and the electrode formed on the other substrate may include an IZO film.

### (Alignment Films)

The alignment films may be any publicly known alignment films without particular limitations. The polymer constituting the alignment films may have a planar alignment group and/or a vertical alignment group. Examples of the material constituting the alignment films include the following polyimide-based alignment agents.

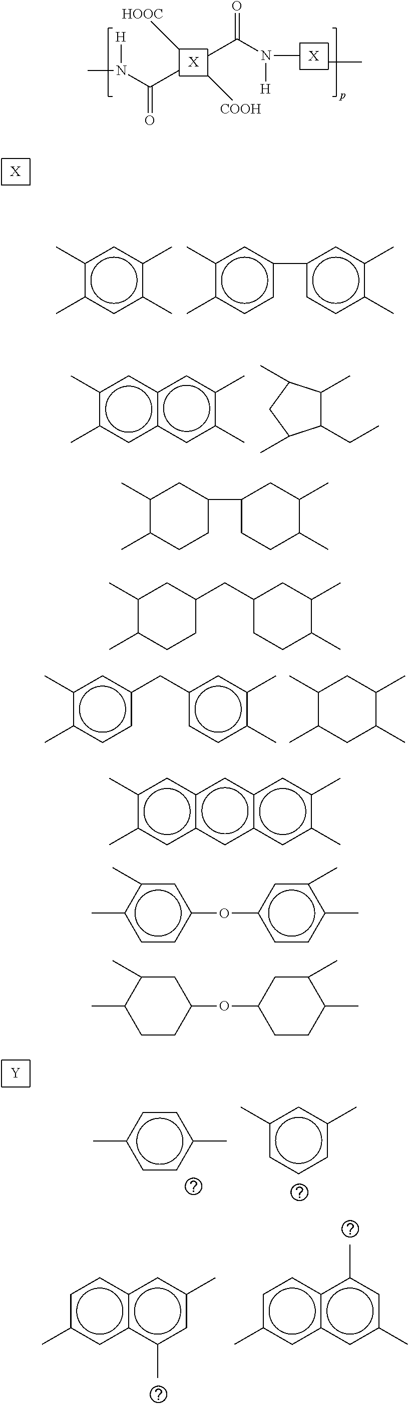

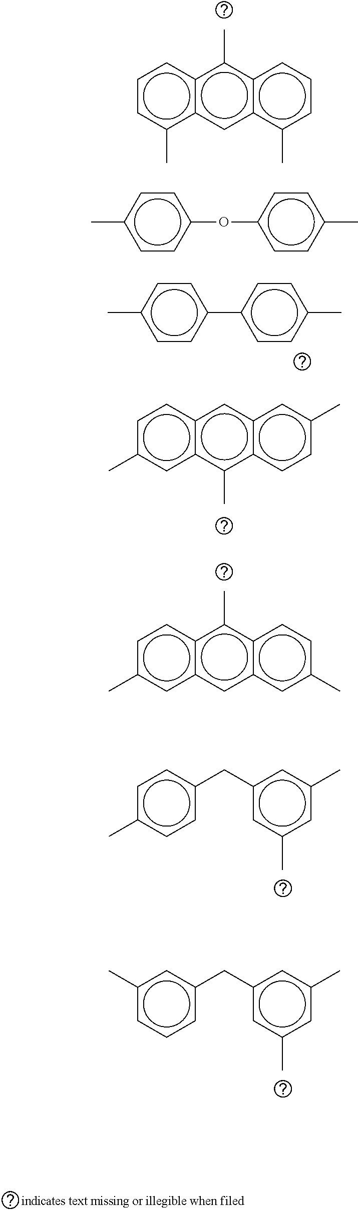

In the formulas for Y, ※ mean positions at which the following groups can be bonded.

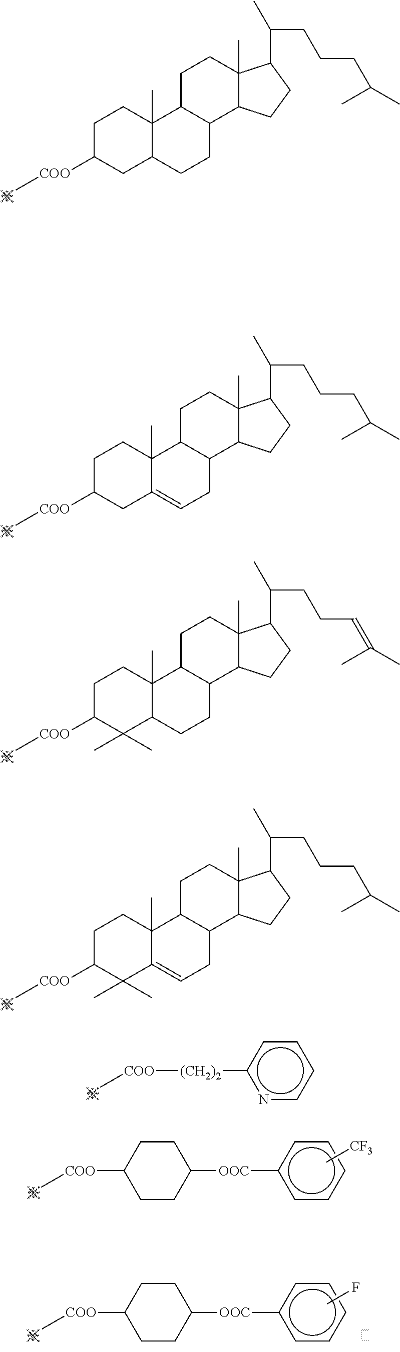

The polyimide-based alignment agent is an alignment agent used during alignment treatment performed by rubbing. Instead of rubbing, alignment treatment can also be performed by irradiation with light energy. An alignment agent used for such an alignment treatment performed by irradiation with light energy may be a polyimide-based alignment agent including a photoreactive functional group. The photoreactive functional group can be selected from groups having an azobenzene skeleton, a cinnamate skeleton, and a cyclobutane ring. More specifically, examples include polyimide-based alignment agents including the following photoreactive functional groups.

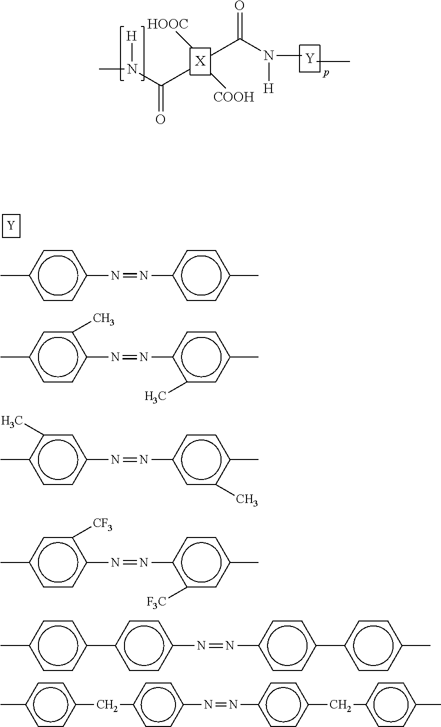

In the above-described general formula, X is any one of the following moiety formulas.

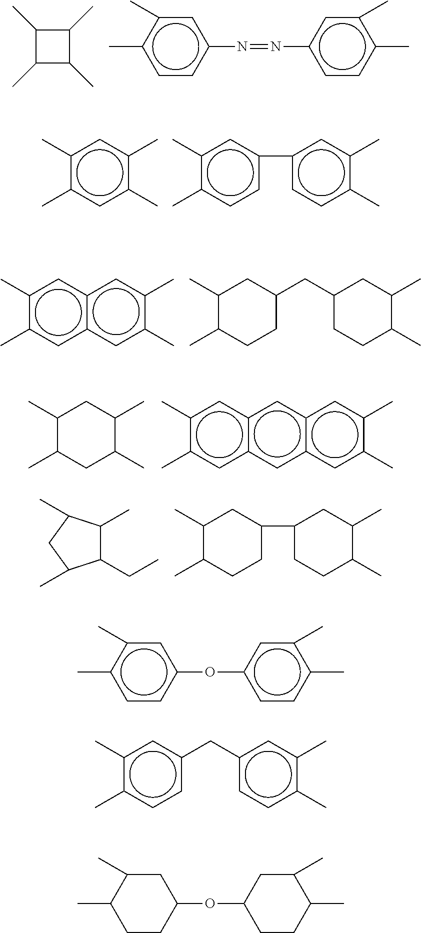

Among these moiety formulas, the upper-left tetravalent group derived from cyclobutane is often employed for an alignment agent for performing alignment treatment by radiating light energy to decompose the alignment agent. The upper-right tetravalent group derived from azobenzene is often employed for an alignment agent for performing alignment treatment by isomerization.

The thickness of the alignment films is not particularly limited, and is generally 80 to 1000 nm.

### (Liquid Crystal Layer)

The liquid crystal material constituting the liquid crystal layer is not particularly limited, and may be any publicly known liquid crystal material. In particular, in order to improve the response performance (to faster responses) of a liquid crystal display, alkenyl compounds represented by the following formulas are preferably used as liquid crystal materials.

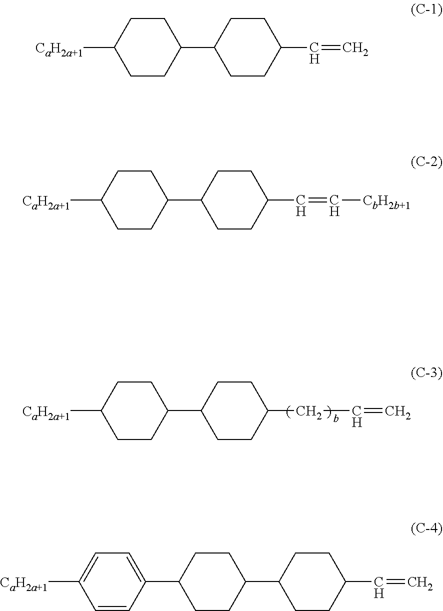

In these formulas, a and b are the same or different integers, and are preferably 1 to 6.

The alkenyl compound included in the formula (C-1) may be specifically a compound represented by the following structural formula.

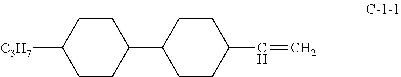

The thickness of the liquid crystal layer is not particularly limited, and is generally 1800 to 5000 nm.

### (Other Elements)

The liquid crystal display may have, in addition to the above-described elements, various and publicly known elements. Examples include a polarizing film, a color filter, a transistor, and an insulating layer covering the transistor. The insulating layer may contain naphthoqiinone diazide (NQD).

### EXAMPLES

### Example 1

As one substrate, a substrate having an MRS constituted by an interlayer dielectric was prepared. On the MRS structure, an aluminum film having a thickness of 100 Å and an ITO film having a thickness described in Table 1 below were formed in this order by vapor deposition, to obtain reflective pixel electrodes. Incidentally, in Table 1, 0 Å means that an ITO film was not formed and the reflective pixel electrodes were constituted by an aluminum film alone.

On the other substrate, a common electrode constituted by an ITO film was formed.

On the reflective pixel electrodes and the common electrode, an alignment agent used for a vertical rubbing alignment film and composed of a blend polymer of the following structural formulas (a) and (b) (blending ratio of 1:1 (weight ratio)) was applied to each of the upper and lower substrates to a film thickness of 1200 Å.

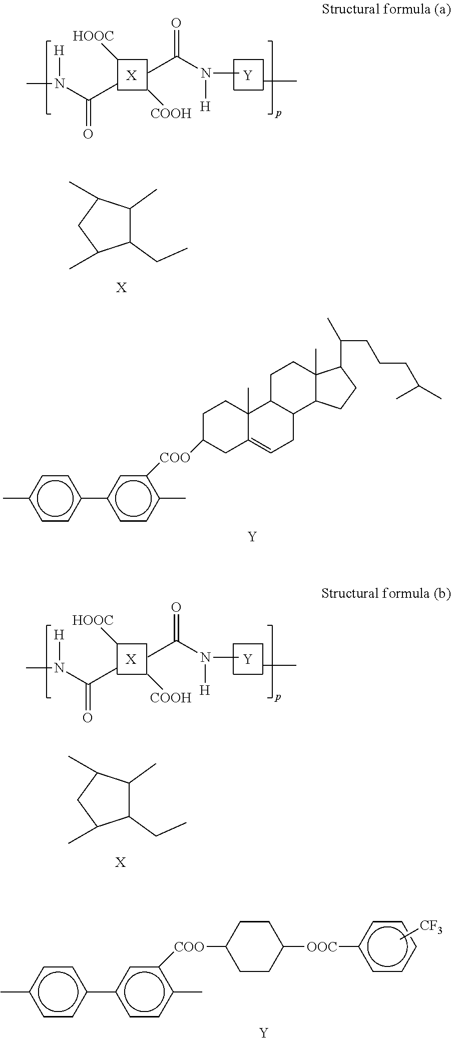

The obtained coating films were subjected to preliminary firing at 70° C. for 1 minute, and firing at 200° C. for 20 minutes, to obtain alignment film precursors. Subsequently, the alignment film precursors were subjected to rubbing treatment, and then washed (with water) to obtain alignment films. A dispenser was used to apply a UV-curable sealing agent (manufactured by SEKISUI CHEMICAL CO., LTD., trade name: Photolec S-WB) to the peripheral region of the one substrate. To a predetermined position of the other substrate, a negative liquid crystal composition (De=−5.5, manufactured by DIC Corporation) was dropped. After the dropping, in vacuum, both substrates were bonded together and the sealing agent was cured with ultraviolet light. Subsequently, heating at 130° C. for 40 minutes was carried out to perform re-alignment treatment of turning the negative liquid crystal composition to an isotropic phase. After the re-alignment treatment, cooling to room temperature was performed to obtain a reflection-mode vertical alignment liquid crystal cell (liquid crystal display).

### (AC 3 V Electrification Test at 90° C. and Contrast Measurement)

In order to evaluate the heat resistance of the liquid crystal cell, under an AC 3 V (1 Hz square wave) electrification environment at 90° C., a voltage holding ratio (VHR) and a residual DC (rDC) were measured before and after leaving for 1000 hours. The measurement of VHR was performed with a VHR measurement system, Model 6254, manufactured by TOYO Corporation, under conditions of 1 V and 70° C. The measurement of rDC was performed such that rDC after application of a DC offset voltage of 2 V was measured by a flicker minimizing method. The contrast was measured at room temperature of 25° C. with a luminance meter (SR-5000, manufactured by Topcon Corporation).

The obtained results are described in Table 1.

TABLE 1

| ITO | Before storage | | | After 1000 h | |
|---|---|---|---|---|---|
| film thickness | VHR | rDC | | VHR | rDC |
| (Å) | (%) | (mV) | Contrast | (%) | (mV) |
| 0 | 99.4 | −25 | 15 | 82.5 | 200 |
| 50 | 99.4 | −10 | 15 | 94.7 | 15 |
| 100 | 99.4 | −10 | 15 | 98.1 | 10 |
| 500 | 99.4 | −10 | 15 | 98.3 | 10 |

In the case of not forming an ITO film (in the case of an ITO film thickness of 0 Å), VHR was found to decrease to the value of less than 85% in the AC 3 V electrification test at 90° C., and rDC was found to be more than 200 mV.

In all the cases of forming an ITO film, VHR and rDC were both found to increase.

No difference was found between the case of an ITO film thickness of 100 Å and the case of an ITO film thickness of 500 Å. Thus, when the ITO film thickness is 100 Å or more, the difference in charge storage amounts inferentially does not occur.

The contrast measurement results have revealed that ITO film thicknesses of 500 Å or less do not affect the contrast.

### Example 2

As in Example 1, an aluminum film having a thickness of 100 Å and an ITO film having a thickness of 100 Å were formed in this order by vapor deposition to obtain reflective pixel electrodes.

Subsequently, on the other substrate, a common electrode constituted by an IZO film having a thickness of 100 Å was formed.

Subsequently, zeolite inorganic fine particles (SiOm-AlOn manufactured by Nakamura Choukou Co., Ltd.) having an average size of 30 nm were introduced to and dispersed, in an amount of 4.0 mass %, in ethanol, to obtain an inorganic layer-forming coating liquid containing inorganic fine particles.

To the alignment agent in Example 1, the zeolite inorganic fine particles (SiOm.AlOn manufactured by Nakamura Choukou Co., Ltd.) having an average size of 30 nm were introduced and dispersed at a concentration described in Table 2, to obtain an alignment film-forming coating liquid containing inorganic fine particles. A reflection-mode vertical alignment liquid crystal cell (liquid crystal display) was obtained as in Example 1 except that the obtained coating liquids were used. The obtained liquid crystal cell was measured in terms of VHR, rDC, and contrast as in Example 1. In Table 2, 0 mass % means that the alignment films did not include inorganic fine particles.

The obtained results are described in Table 2.

TABLE 2

| Inorganic fine | Before storage | | | After 1000 h | |
|---|---|---|---|---|---|
| particle content | VHR | rDC | | VHR | rDC |
| (mass %) | (%) | (mV) | Contrast | (%) | (mV) |
| 0 | 99.4 | −35 | 15 | 82.5 | 230 |
| 0.5 | 99.4 | −10 | 15 | 89.3 | 80 |
| 1.0 | 99.4 | −10 | 15 | 93.4 | 60 |
| 1.5 | 99.4 | −10 | 15 | 96.2 | 10 |

In the case of not including inorganic fine particles (0 mass %), VHR was found to decrease to the value of less than 85% in the AC 3 V electrification test at 90° C., and rDC was found to be more than 200 mV.

In the cases of including inorganic fine particles, the decrease in VHR and the increase in rDC were suppressed. With an increase in the content, the improvement effects on VHR and rDC became stronger. However, when the inorganic fine particle content was 2.0 mass %, alignment disorder occurred after injection of liquid crystal.

When the inorganic fine particle content was less than 2.0 mass %, the contrast was maintained at 15; however, when the inorganic fine particle content was 2.0 mass %, the contrast was less than 5. This is inferentially caused by alignment disorder due to the excessive addition of fine particles.

Thus, it has been demonstrated that an inorganic fine particle content of less than 2.0 mass % provides improvements in VHR and rDC.

### Example 3

As in Example 1, an aluminum film having a thickness of 100 Å and an ITO film having a thickness of 100 Å were formed in this order by vapor deposition to obtain reflective pixel electrodes.

Subsequently, on the other substrate, a common electrode constituted by an IZO film having a thickness of 100 Å was formed.

An alignment-film-forming coating liquid was obtained as in Example 2 except for use of an alignment agent composed of a blend polymer of structural formulas (c) and (d) below (blending ratio of 1:1 (weight ratio)). The obtained coating liquid was applied to each of the upper and lower substrates to a film thickness of 1200 Å.

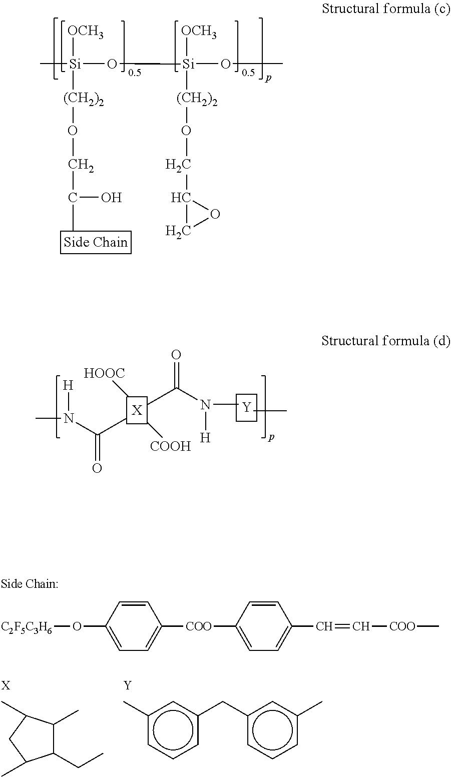

The obtained coating films were subjected to preliminary firing at 90° C. for 5 minutes and firing at 230° C. for 40 minutes to obtain fired films. The fired films were irradiated with linearly polarized ultraviolet light centered at 330 nm, in an oblique direction at 40° relative to the surfaces of the substrates at an energy of 25 md/cm, to thereby obtain alignment films having been subjected to alignment treatment and containing inorganic fine particles. Subsequently, as in Example 1, a UV2A-mode liquid crystal cell (liquid crystal display) was obtained. The obtained liquid crystal cell was measured in terms of VHR, rDC, and contrast as in Example 1. Incidentally, in Table 3, 0 mass % means that the alignment films did not include inorganic fine particles.

The obtained results are described in Table 3.

TABLE 3

| Inorganic fine particle | Before storage | | | After 1000 h | |
|---|---|---|---|---|---|
| content | VHR | rDC | | VHR | rDC |
| (mass %) | (%) | (mV) | Contrast | (%) | (mV) |
| 0 | 99.4 | −40 | 18 | 82.5 | 280 |
| 0.5 | 99.4 | −20 | 18 | 89.3 | 80 |
| 1.0 | 99.4 | −20 | 18 | 93.4 | 55 |
| 1.5 | 99.4 | −20 | 18 | 96.2 | 15 |

In the case of not including inorganic fine particles (0 mass %), VHR was found to decrease to the value of less than 85% in the AC 3 V electrification test at 90° C., and rDC was found to be more than 200 mV.

In the cases of including inorganic fine particles, the decrease in VHR and the increase in rDC were suppressed. With an increase in the content, improvement effects on VHR and rDC became stronger. However, when the inorganic fine particle content was 2.0 mass %, alignment disorder occurred after injection of liquid crystal.

When the inorganic fine particle content was less than 2.0 mass %, the contrast was maintained at 18. However, when the inorganic fine particle content was 2.0 mass %, the contrast became less than 5.

Thus, it has been demonstrated that an inorganic fine particle content of less than 2.0 mass % provides improvements in VHR and rDC.

### REFERENCE SIGNS LIST

1: ITO film, 2 and 4: alignment films, 3: IZO film, 5: liquid crystal layer, a: one substrate, b: the other substrate, c: TFT, d: pixel electrode, e: insulating film, f: incident light, g: reflected light, Ra: reflection region, Ta: transmission region, h: color filter, i: transmissive electrode, j: transmitted light, k: common electrode, 1: alignment film, m: liquid crystal layer, n: alignment film, nr: alignment film in reflection region, nt: alignment film in transmission region, and o: transparent electrode.

1. A liquid crystal display at least comprising: a pair of substrates constituted by one substrate and another substrate, an electrode and an alignment film formed in this order on each of the pair of substrates, and a liquid crystal layer held between the alignment films,
wherein the alignment films include a polymer, and
the electrode formed on the one substrate has a multilayered structure in which an aluminum film and a transparent electroconductive film are stacked in this order from the one substrate.

2. The liquid crystal display according to claim 1, further comprising an inorganic layer on the alignment film formed on the one substrate.

3. The liquid crystal display according to claim 1, wherein the alignment film formed on the one substrate is an alignment film containing inorganic fine particles.

4. The liquid crystal display according to claim 3, wherein the alignment film containing inorganic fine particles contains inorganic fine particles having a particle size of 1 to 50 nm, and a content of the inorganic fine particles relative to 100 parts by mass of the polymer is more than 0 mass % and less than 2.0 mass %.

5. The liquid crystal display according to claim 3, wherein the inorganic fine particles are fine particles containing SiOx.

6. The liquid crystal display according to claim 3, wherein the inorganic fine particles are fine particles containing SiOx.AlOy (where x and y are the same or different numbers).

7. The liquid crystal display according to claim 1, wherein the polymer has a planar alignment group or a vertical alignment group.

8. The liquid crystal display according to claim 1, wherein the polymer includes a photoreactive functional group.

9. The liquid crystal display according to claim 8, wherein the photoreactive functional group is selected from groups having an azobenzene skeleton, a cinnamate skeleton, and a cyclobutane ring.

10. The liquid crystal display according to claim 1, wherein the liquid crystal layer includes, as a liquid crystal material, a compound having an alkenyl skeleton.

11. The liquid crystal display according to claim 10, wherein the compound having an alkenyl skeleton is at least one selected from the group consisting of compounds represented by formulas (C-1) to (C-4) below: 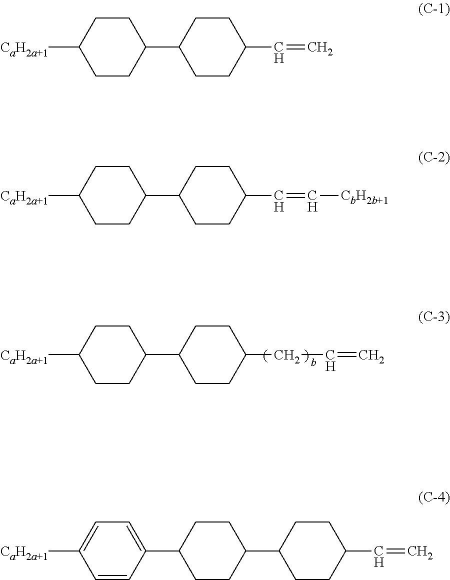
(where a and b independently represent an integer of 1 to 6).

12. The liquid crystal display according to claim 1, wherein the liquid crystal display is a reflection-mode display.
